(19) United States
(12) Patent Application Publication
(10) Pub. No.: US 2010/0192790 A1
(43) Pub. Date: Aug. 5, 2010

(54) Printing Cylinder or Printing Sleeve with Insert

(75) Inventor: Michiel Van der Meulen, Arnhem (NL)

Correspondence Address: VENABLE LLP, P.O. BOX 34385, WASHINGTON, DC, 20043-9998, US

(73) Assignee: Mueller Martini Druckmaschinen GmbH, Maulburg (DE)

(21) Appl. No.: 12/552,786

(22) Filed: Sep. 2, 2009

Related U.S. Application Data
(63) Continuation of application No. PCT/NL2008/000064, filed on Feb. 28, 2008.

(30) Foreign Application Priority Data
Mar. 2, 2007 (NL) 1033484

(51) Int. Cl. B41F 31/00; B23P 17/04

(52) U.S. Cl. 101/351.7; 29/525.01

(57) ABSTRACT

A printing cylinder or printing sleeve including an internal structure that is at least partially open and the internal structure defines a hollow space. A substantially liquid-tight cylindrical outer layer surrounds the internal structure and a coupling device couples a plate to the printing cylinder or printing sleeve. The coupling device is at least partially positioned in, on, or under the outer layer. An insert is supported by the internal structure and is arranged at least partially around or under the coupling device. The insert is constructed to impart strength to the coupling device.

### CROSS-REFERENCE TO RELATED APPLICATION

This application is a continuation of PCT Application No. PCT/NL2008/000064 entitled “Printing Cylinder or Printing Sleeve with Insert,” filed Feb. 28, 2008, which claims the priority of Netherlands Application No. NL 1033484 filed Mar. 2, 2007, both of which are incorporated herein by reference in their entirety.

### BACKGROUND OF THE INVENTION

The invention relates to the field of printing, in particular offset printing. In particular, the invention relates to a printing cylinder or printing sleeve with an insert and to a method for producing a printing cylinder or printing sleeve with an insert.

Printing cylinders or printing sleeves are known in the state of the art. In general, in offset printing, three cylinders are used. A first cylinder is covered on the exterior with a printing plate on which the image to be printed is provided. A second cylinder is covered with a rubber blanket onto which an image from the first cylinder can be transferred. Such a rubber blanket may be bonded directly to the cylinder, or bonded to a metal plate which is attached to the cylinder. Finally, there is a third cylinder which acts as a counterpressure cylinder. In practice, both the printing plate and the rubber blanket have to be replaced at regular intervals.

The present structure relates in particular to the first and second cylinder. The second cylinder is situated essentially between the first and third cylinder. The axes of rotation of the cylinders extend substantially parallel to one another.

EP 0127953 discloses a printing cylinder which has a partially open internal structure and as a result has a relatively low weight. A drawback of the printing cylinder according to EP0127953 is that it is less suited to providing a printing plate or rubber blanket plate thereon.

### SUMMARY

It is an object of the invention to at least partially overcome one or more of the drawbacks mentioned or to at least provide an alternative.

According to one aspect of the invention, there is provided a printing cylinder or printing sleeve comprising: an internal structure which is at least partially open, wherein the internal structure defines at least one hollow space; a substantially liquid-tight cylindrical outer layer surrounding the internal structure; a coupling device to couple a plate to the printing cylinder or printing sleeve, the coupling device being at least partially positioned in, on, or under the outer layer; an insert supported by the internal structure, the insert being arranged at least partially around or under the coupling device, the insert being constructed to impart strength to the coupling device.

According to a further aspect of the invention, there is provided a method for producing a printing cylinder or printing sleeve, comprising: providing an internal structure which is at least partially open, wherein the internal structure defines at least one hollow space; providing a substantially liquid-tight cylindrical outer layer surrounding the internal structure; providing a coupling device to couple a plate to the printing cylinder or printing sleeve, the coupling device being at least partially positioned in, on or under the outer layer; and providing an insert around or under the coupling device, the insert being designed to impart strength to the coupling device and the insert being supported by the internal structure.

It is a further object of the invention to provide a printing cylinder or printing sleeve having a low weight and a strong connection for a jacket which is to be provided around the printing cylinder or printing sleeve. At least one of these objects is achieved with a printing cylinder or printing sleeve according to embodiments of the invention.

The open internal structure supports the outer layer and thus makes it possible to exert pressure with the printing cylinder or printing sleeve. At the same time, the hollow spaces result in a cylinder which is lighter than a solid cylinder. By providing the coupling means, such as a holding groove, in the insert, the coupling means are prevented from forming an opening through which liquid can pass and through which, for example, ink and/or water could penetrate into the hollow spaces in the cylinder.

The insert may be elongate, have the shape of a beam and extend in the direction of the axis of the printing cylinder. Inherently, the insert has substantial strength, and does not have to be supported along its entire length by the internal structure. This makes it possible for the internal structure to be partially open and define hollow spaces. Despite the hollow spaces, the insert may be sufficiently strong to form a strong coupling between the printing cylinder and the jacket which is to be provided around it.

The insert is designed to contribute to securing a jacket which can be provided around the outer layer. If a groove is used, it is possible to clamp a strip of the jacket therein. Of course, it is also possible to use other suitable coupling means which are known to those skilled in the art.

In one aspect, the insert is in and/or under a recess in the substantially closed outer layer. This is a simple way of achieving the required strength. The insert can define the groove and thus form the coupling device.

In one aspect, the partially open internal structure of the printing cylinder or printing sleeve comprises partitions or cups which support the outer layer, thus resulting in a lightweight cylinder.

In another embodiment, the partitions have recesses for accommodating the insert therein. In this manner, it may be possible to support the insert in a simple manner.

Preferably, at least a part of the partitions comprise a conical part. This results in a good stackability of the partitions.

Preferably, the insert comprises abutment surfaces which adjoin corresponding abutment surfaces on the outer layer. This makes it possible to provide a simple liquid-tight connection between the insert and the outer layer, preferably by bonding.

In one aspect, at least one abutment surface extends obliquely with respect to a radial direction, thus resulting in a good liquid-tight connection. Further preferred embodiments of the device and method are described in the dependent claims.

### BRIEF DESCRIPTION OF THE DRAWINGS

The present invention will be more readily understood from the following detailed description when read in conjunction with the accompanying drawings, in which identical parts are denoted by the same reference numerals, and in which:

FIGS. 1A and 1B show a cross section through a printing cylinder according to the invention;

FIG. 2 shows a detailed cross section of the printing cylinder according to the invention;

FIGS. 3A and 3B show further details in cross section of the outer edge and inner edge of the printing cylinder according to the invention;

FIGS. 4A and 4B show a cup in cross section with and without an outer edge;

FIG. 4C shows a cup in a perspective view;

FIG. 4D shows a front view of a cup;

FIG. 4E shows a perspective view of a cup from which a part has been removed;

FIG. 5 shows a diagrammatic view of the production of the printing cylinder or printing sleeve according to the method;

FIG. 6 shows a cross section of a printing cylinder according to prior art, at right angles to the axis of rotation;

FIG. 7 shows a graph in which the thickness of and the distance between the cups are plotted out.

FIG. 8 shows a cross section of a detail of an embodiment of the insert;

FIG. 9 shows a cross section of a detail of another embodiment of the insert;

FIG. 10 shows a cross section of a detail of yet another embodiment of the insert;

FIG. 11 shows a cross section of a detail of still another embodiment of the insert;

FIG. 12 shows a cross section of a detail of an embodiment of the insert;

FIG. 13 shows a cross section of a detail of another embodiment of the insert;

FIG. 14 shows a cross section of a detail of still another embodiment of the insert; and

FIG. 15 shows a cross section of a printing cylinder containing a groove.

### DETAILED DESCRIPTION

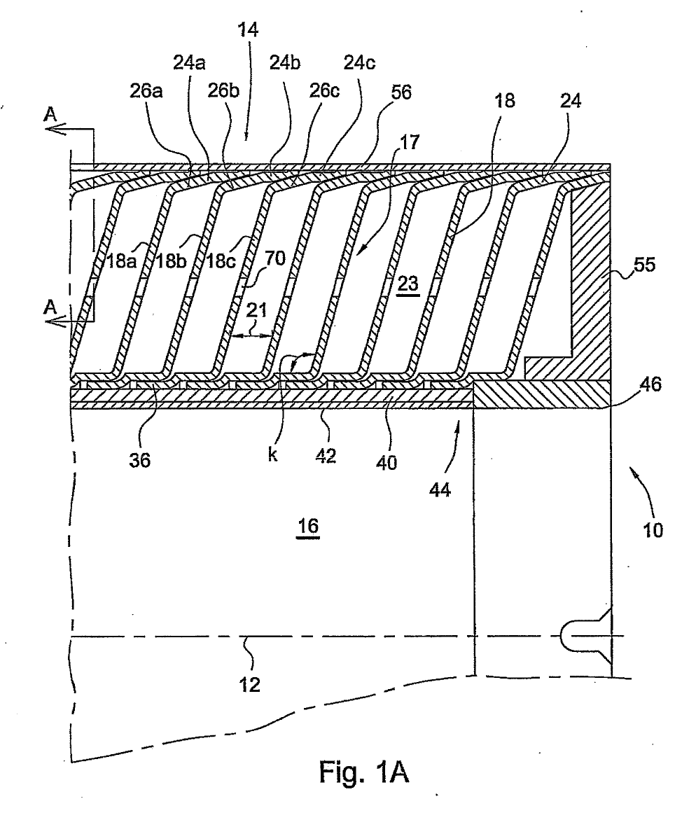

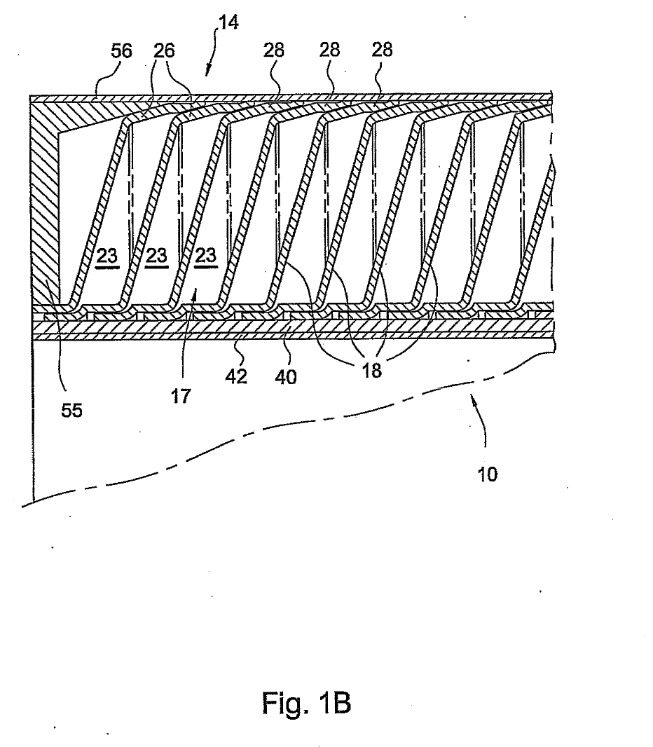

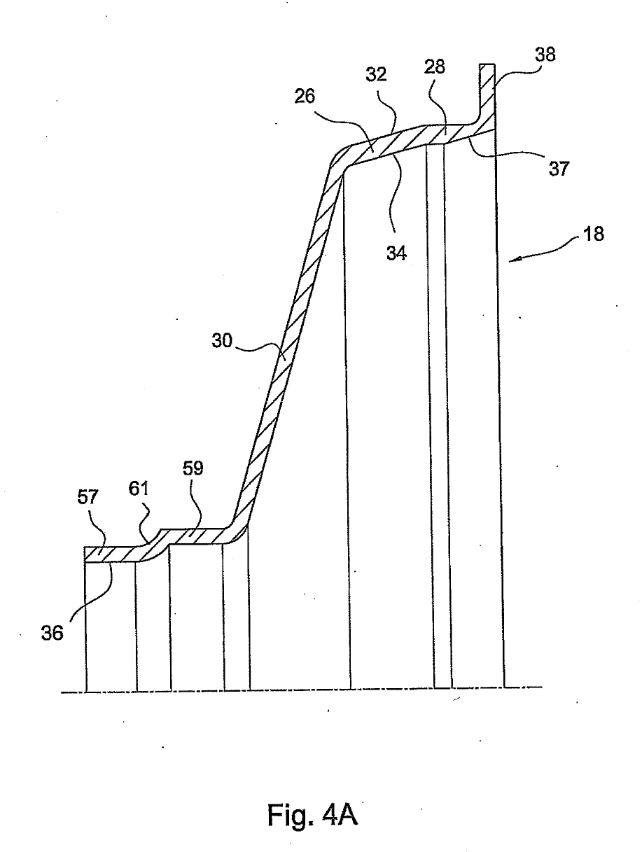

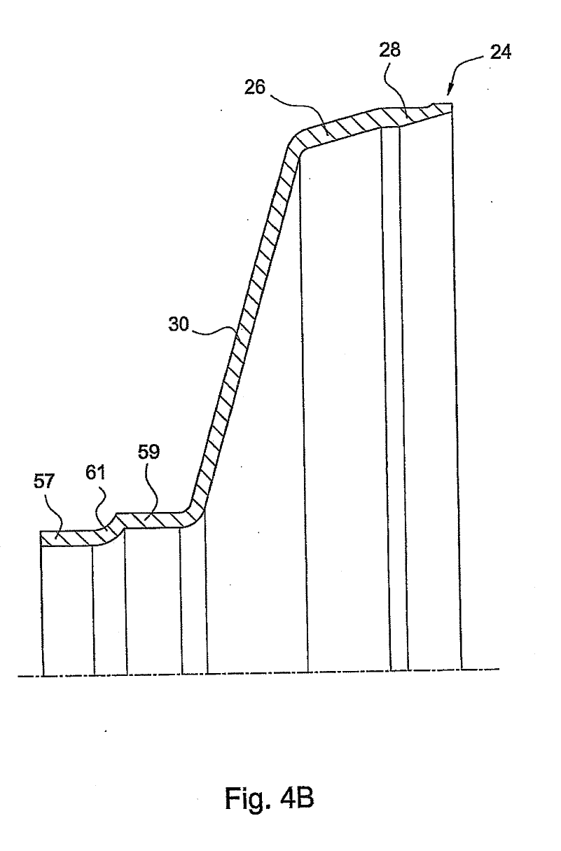

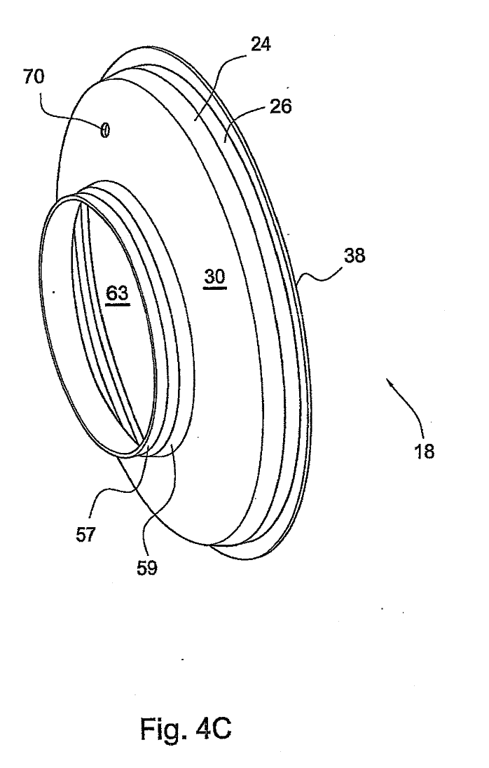

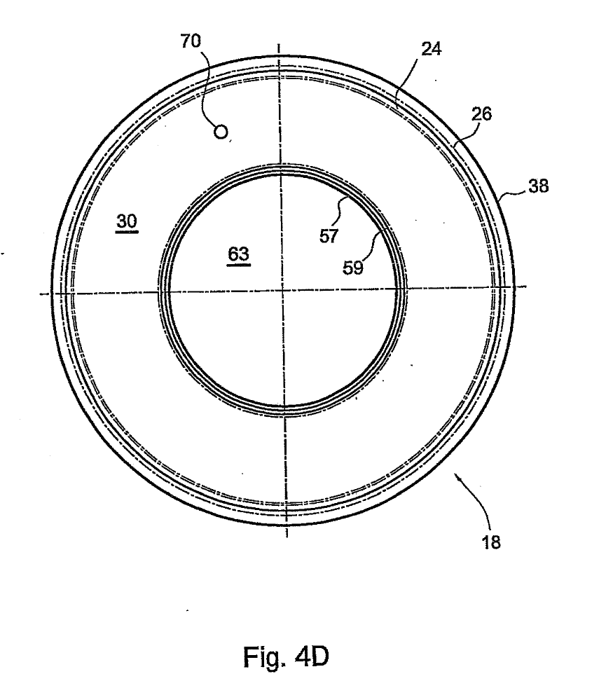

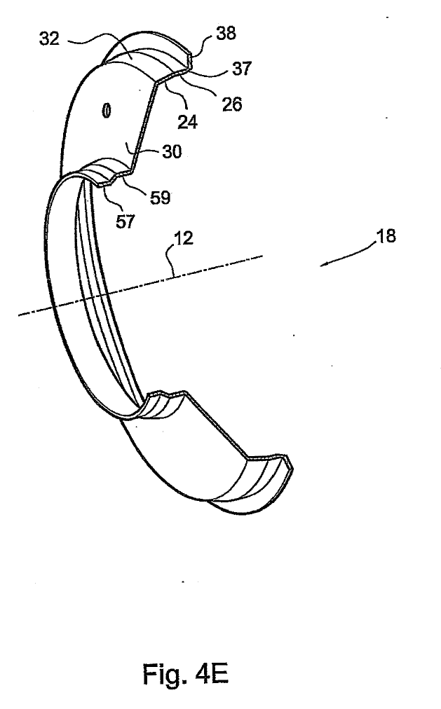

FIGS. 1A, 1B, 2, 3A and 3B show a printing cylinder or printing sleeve 10 according to the invention for use in an offset printing machine. FIGS. 4A to 4E show a cup 18. The printing cylinder 10 has a centre axis or axis of rotation 12, an exterior 14, and a cylindrical aperture 16 which is designed to be positioned around a cylinder shaft or mandrel (not shown). The embodiment illustrated in FIG. 1 is thus a printing sleeve.

The printing sleeve 10 may be fixedly connected to the respective cylinder shaft or be detachably connected thereto. In the latter case, the cylinder shaft is often fixedly connected to the printing machine and is also referred to as a mandrel.

The printing sleeve comprises an internal structure 17 which supports an outer layer 56 on the exterior 14 of the printing sleeve 10.

The internal structure 17 is composed of a number of annular cups 18. Preferably, the plurality of cups is substantially identical. The cups 18 are positioned at an intermediate distance 21 in the axial direction and thus define hollow spaces 23.

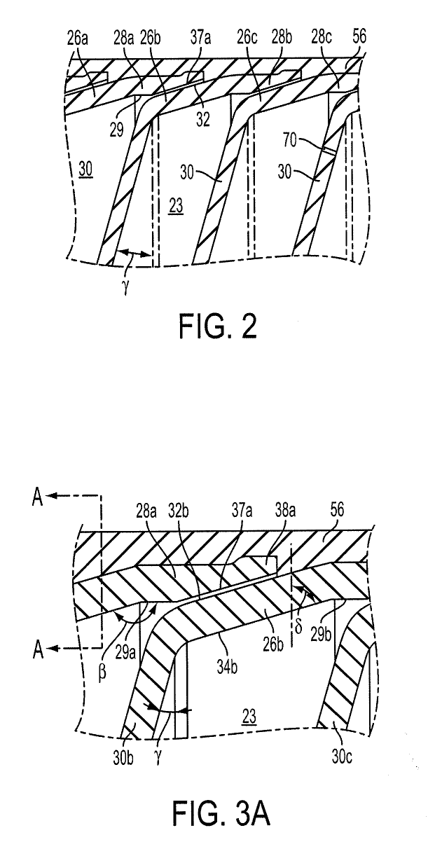

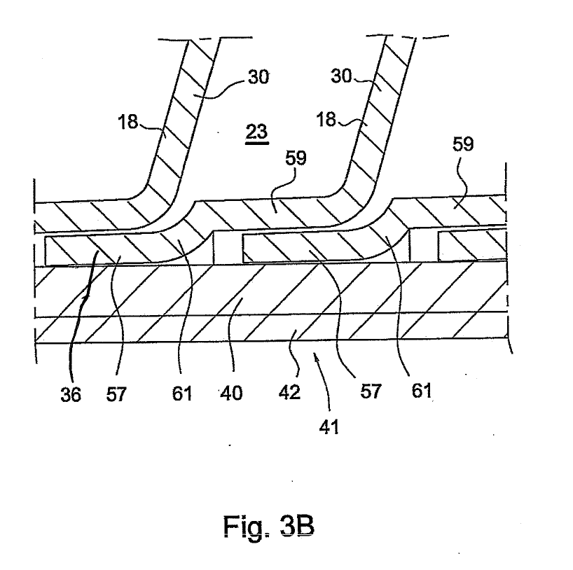

The radially outer edges 24 of the plurality of cups 18 together form a substantially cylindrical surface. Each radially outer edge 24 (24a, 24b, 24c, etc., respectively) of the respective cups 18 (18a, 18b, 18c, respectively) comprises a conical wall part 26 (26a, 26b, 26c, respectively) and a substantially cylindrical wall part 28 (28a, 28b, 28c, respectively) (see FIGS. 2 and 3A), which are connected to one another at an obtuse angle β. Each of the plurality of cups 18 furthermore comprises a central disc 30 and a radially inner edge 36.

The conical wall part 26 is delimited by an outer conical surface part 32 and an inner conical surface part 34. On the inside, the substantially cylindrical wall part 28 also comprises a conical surface part 37. The conical surface part 37 of the cylindrical wall part 28 is complementary to the outer conical surface part 32 of the conical wall part 26. As a result, it is possible to connect a plurality of cups 18 to one another, with the conical surface part 32b of one cup 18 being turned towards the conical surface part 37a of an adjacent cup for forming a connection.

The inner conical surface part 34 and the conical surface part 37 are separated from one another by a cylindrical surface part 29. In one embodiment, the cylindrical surface part 29 is not present, and the conical surface part 34 and the conical surface part 37 together form a single, continuous surface part.

In this exemplary embodiment, the contact connection is an adhesive connection, in particular an adhesive connection on the basis of acrylate adhesive. A methyl acrylate adhesive is particularly suitable. Other connections, including (spot) welding, soldering, bolted connections, clamp connections or other suitable connections are likewise possible.

The central disc 30 of the cup is also conical, with the central disc 30 being at a smaller angle γ with respect to an imaginary radial plane than the radially outer edge 24. The central disc 30 of the cup 18 and the radially outer edge 24 are at an obtuse angle to one another.

The radially inner edge 36 and the central disc 30 of the cup are at an obtuse angle κ to one another (FIG. 1A). Such obtuse angles facilitate the production of the cup 18 and reduce the risk of cracks which may occur during production, or as a result of fatigue during use.

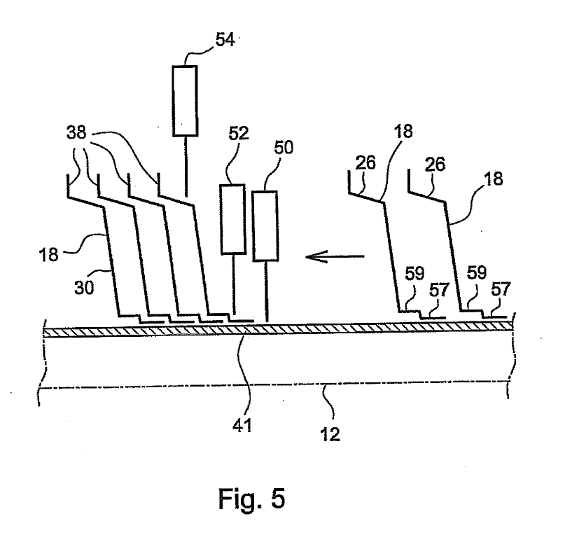

The radially inner edge 36 of the cup 18 comprises a first part 57 which extends substantially axially and a second part 59 which extends substantially axially (FIG. 3B). The second part 59 is at a slightly greater distance to the centre axis than the first part 57. The first part 57 is in contact with the inner sleeve 41, and is connected thereto, for example bonded thereto, see also FIG. 5. The second part 59 is in contact with a first part 57 of an adjacent cup 18 and is likewise secured and/or fixedly connected thereto. A transition part 61 connects the first part 57 to the second part 59. The second part 59 is also referred to as the insertion part, and the first part 57 is also referred to as the end. The substantially axial part 57 defines a passage or opening 63.

In another embodiment for a cylinder, it is also possible to use a cup 18 without passage 63. Together, the cups are designed to keep an adjacent cup centered about a common virtual centre axis 12. It is thus possible to form a cylinder 10 without inner sleeve 41.

The cups 18 are made of aluminum. Cups are formed out of an aluminum disc by means of spinning. After spinning, the central disc 30 of the cup 18 has a thickness of essentially 1.5 mm. The outer edge 24 has a thickness of essentially 2 mm. However, other thicknesses are also possible.

On the outer edge 24 of the cups described above in detail, there is also an auxiliary edge 38 which extends outwards in a radial direction of the outer edge 24.

As is shown in FIG. 2, a cup 18 may have an air aperture to prevent pressure differences between the hollow spaces 23 during production and during use of the cylinder.

FIG. 5 shows a phase during and method for producing the printing sleeve. The cups 18 are pickled and provided with a first adhesive component. Then, an inner cylinder 41, in particular a hollow inner cylinder or inner sleeve is provided. This inner sleeve 41 comprises an inner tube 42 made of glass-fibre-reinforced plastic, around which an outer layer 40 of compressible open-cell or closed-cell plastic foam is provided. First though, a register ring 46 is provided on the inner sleeve 41, near one end 44 thereof (FIG. 1A).

The cups 18 are then one by one pushed around the inner sleeve 41, with the first cup 18 being connected to the register ring 46 by means of an adhesive connection. After a cup has been pushed into its position, a second adhesive component is applied by means of adhesive valves, in particular by three adhesive valves 50, 52, 54 simultaneously (see FIG. 5).

Thereafter, a subsequent cup 18 is pushed onto the inner sleeve 41 and pressed onto the adhesive in the previous cup. It is possible to use gluing clamps (not shown) which can then be positioned on the auxiliary edges 38 of two adjacent cups 18 in order to provide a secure clamping arrangement during bonding. Finally, end discs 55 are fitted on the axial ends of the cylinder formed in this way in order to finish the cylinder. The register ring 46 and the end disc 55 ensure that the head ends of the cylinder or sleeve are substantially liquid-tight.

Once sufficient cups 18 have been fitted for the desired cylinder length and the adhesive has cured sufficiently, any gluing clamps which may have been used can be removed. If desired, the adhesive can be subjected to an aftercure using UV-light. The cylinder is then finish-turned during which at least the auxiliary edges 38 are substantially removed. An outer layer 56 of plastic material is applied, for example by (injection-) molding and/or rolling, around the rough cylinder 10 which has thus been formed. After the plastic has cured, the outer layer 56 is finish-turned to the desired diameter and ground.

It should be noted that the expression conical surface also refers to a surface having a varying angle of inclination. Such a surface is thus doubly curved, but can be regarded as a surface which is composed of, viewed in each case in the axial direction, short conical surfaces having a constant angle of inclination.

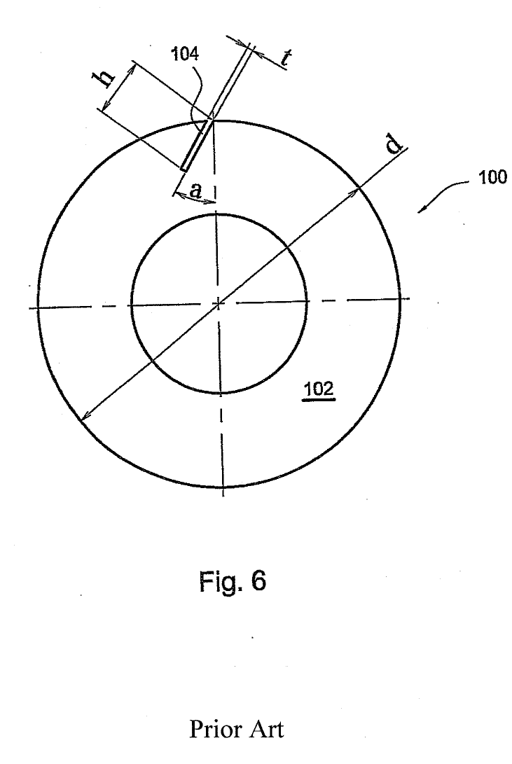

FIG. 6 shows a printing sleeve 100 according to the prior art. The printing sleeve 100 has a solid body 102, which is provided with a groove 104. The solid nature of the printing sleeve in a disadvantageous manner results in a substantial weight of the printing sleeve.

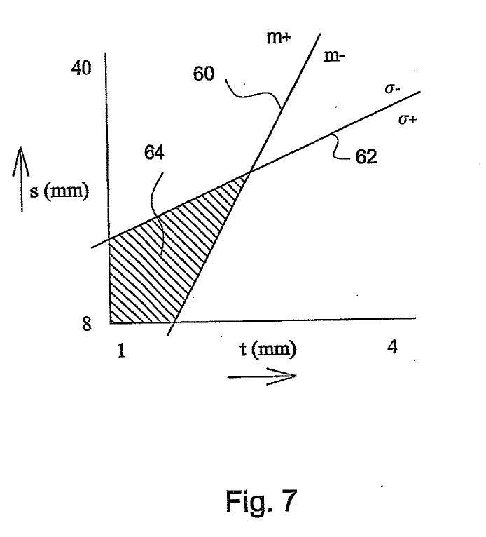

FIG. 7 shows a graph in which, on the horizontal axis, a dimension t is plotted which represents the (average) wall thickness of the cups 18. On the vertical axis, a distance is plotted, which represents the distance of the cups 18 with respect to one another in the axial direction of the printing cylinder or printing sleeve.

The graph shows a first line 60 which divides the area into two halves, m+ and m−. m+represents the area in which the mass of the printing cylinder is sufficiently small and m− represents an area in which the mass of the printing sleeve 10 is deemed to be too large.

The graph also shows a second line 62 which divides the area into two halves, σ+ and σ−. The σ+ indicates the area in which the strength of the printing cylinder is seen as being sufficiently large and σ− indicates an area in which the strength of the printing sleeve 10 is regarded as being insufficient. The hatched area 64 is the area in which the printing sleeve 10 is both sufficiently light and sufficiently strong.

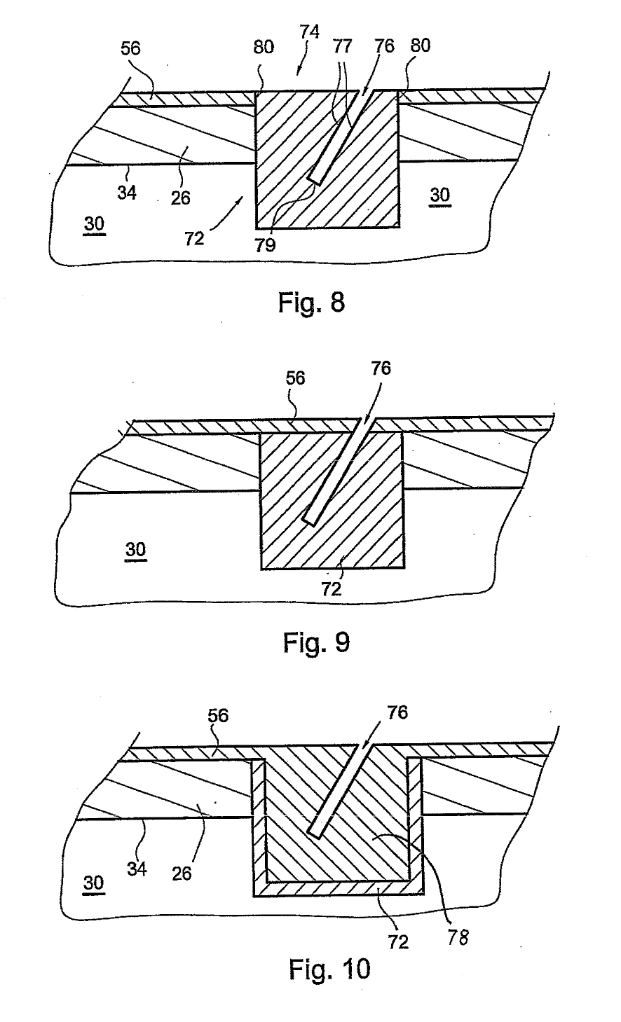

FIG. 8 shows a cross section of a detail of an insert 72 according to the invention along line A-A in FIGS. 1 and 3. The insert 72 is situated in a recess 74 in the outer layer 56 and extends through the conical part 26 of the cups 18.

The insert 72 defines a groove 76 which is suitable for receiving a strip of a jacket (not shown) to be fitted around the printing cylinder or printing sleeve 10, such as a printing plate with an image or a rubber blanket for transferring the image.

The groove has walls 77 and a bottom 79. The insert adjoins the outer layer 56 by means of abutment surfaces 80. The abutment surfaces 80 are situated near the exterior of the printing sleeve 10, more particularly in the outer layer 56 thereof.

In FIG. 8, the insert 72 has a substantially rectangular cross section. The insert is supported by the conical part 26 and the central disc 30 of each cup 18. The conical part 26 and the central disc 30 have a recess for accommodating the insert 72. The insert 72 completely fills the recess. The insert 72 may be a metal extruded profiled section.

FIG. 9 shows an embodiment of an insert 72, in which the insert 72 is situated underneath the outer layer 56. The insert in this case supports the outer layer 56 at the location of the recess 74, which also defines the opening of the groove 76.

FIG. 10 shows an embodiment of an insert 72, in which the outer layer 56, on the inside, viewed in a radial direction, defines a protuberance 78, with the insert 72 supporting the protuberance.

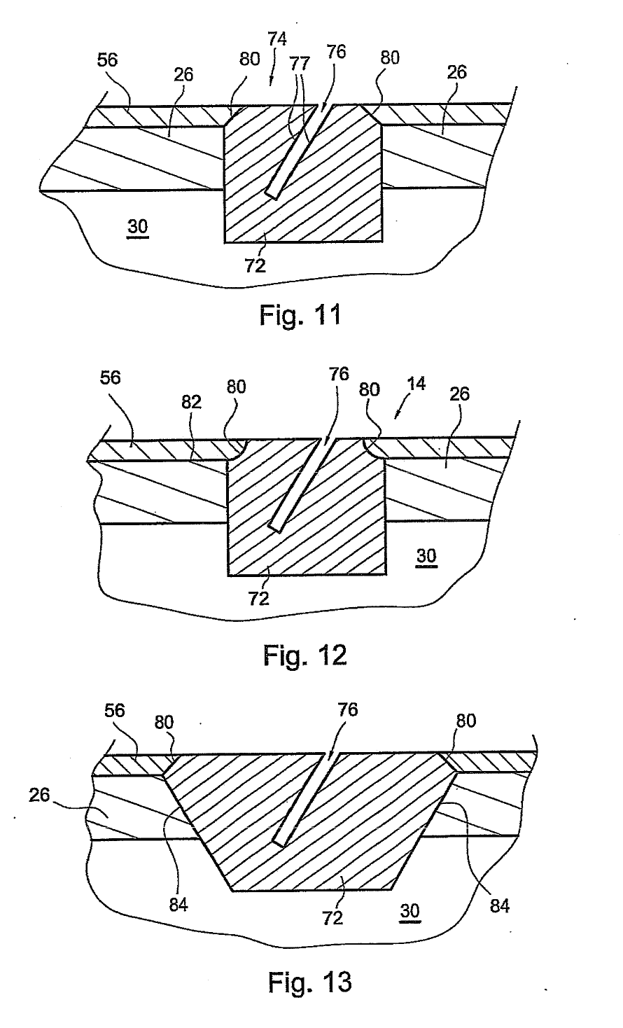

FIG. 11 shows an embodiment in which an insert 72 has abutment surfaces 80 which extend at an angle with respect to the radial direction of the cylinder towards one another.

FIG. 12 shows an embodiment of an insert 72, in which the abutment surfaces 80 are curved. The abutment surfaces 80 extend radially at the location of the exterior 14 of the printing cylinder 10, and the abutment surfaces 80 extend axially at the location of the interior 82 of the outer layer 56.

FIG. 13 shows an embodiment according to the invention, in which an insert 72 has surfaces 84 which extend obliquely outwards with respect to the radial direction of the cylinder. In other words, viewed in a radial direction, the insert 72 has diverging lateral surfaces 84. The diverging surfaces 84 adjoin an aperture in the conical part 26 and the central disc 30 of the cups 18. The cups 18 support the insert 72 at the location of the oblique surfaces 84. One of the advantages of this embodiment is the fact that no adhesive will slide off when the insert 72 is positioned. This is a general advantage of diverging lateral surfaces. In use, the shear forces between diverging lateral surfaces of an insert and the cups will also be smaller than is the case with parallel or converging lateral surfaces.

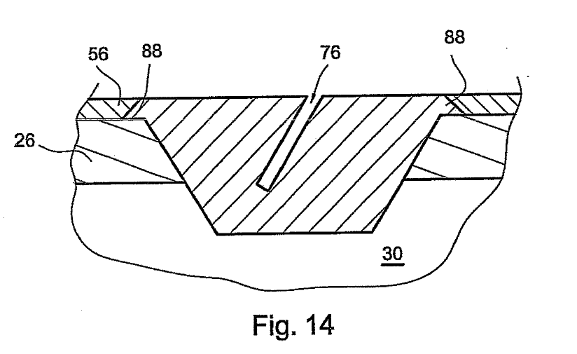

FIG. 14 shows an embodiment of an insert 72 with projecting parts 88. The advantage of the projections 88 is that there is a larger surface available for the adhesive for bonding the insert to the conical part 26 and the central disc 30 of the cups 18. Furthermore, this embodiment makes it simple to seal seams and hollow spaces. In addition, the stress in the material during use is relatively low with this embodiment.

In a variant (not shown) of the embodiment from FIG. 14, surfaces 84 and abutment surfaces 80 both extend in a direction which is oblique with respect to a radial of the cylinder and diverge in a radial direction. In particular, the oblique surfaces 84 continue in the same direction in the abutment surfaces 80.

A general advantage of diverging abutment surfaces 80 may be that the risk of the outer layer 56 and abutment surface 80 becoming detached is reduced. After all, both with converging and with diverging abutment surfaces, the end of the material from which the outer layer 56 is made tapers. With a diverging abutment surface 80, said tapering end is situated underneath the insert 72, viewed in a radial direction. When a force is exerted on the exterior 14 of a printing sleeve or printing cylinder, the insert is pushed firmly onto this tapering end, with any shear forces between the outer layer 56 and the insert 72 remaining relatively small.

With a method for producing the embodiments according to FIGS. 9, 10, 11, 12, 13 and 14, first the cylinder is constructed from the cups 18, as described above. After the auxiliary edges 38 have been removed, an opening for accommodating the insert 72 is produced by milling. Subsequently, the outer layer 56 is applied.

With a method for producing the above-described variant (which has not been shown) of the embodiment from FIG. 14, the outer layer 56 is applied following the removal of the auxiliary edges 38. Once the outer layer 56 has been applied, an opening is milled for accommodating the insert 72. The embodiment according to FIG. 8 can be produced using either of the two sequences.

In general, it is advantageous to apply the outer layer 56 first and to mill a slot afterwards. This facilitates the application and grinding of the outer layer. Generally, this sequence is possible with embodiments of an insert 72 where the side walls run parallel, or diverge with respect to a radial direction.

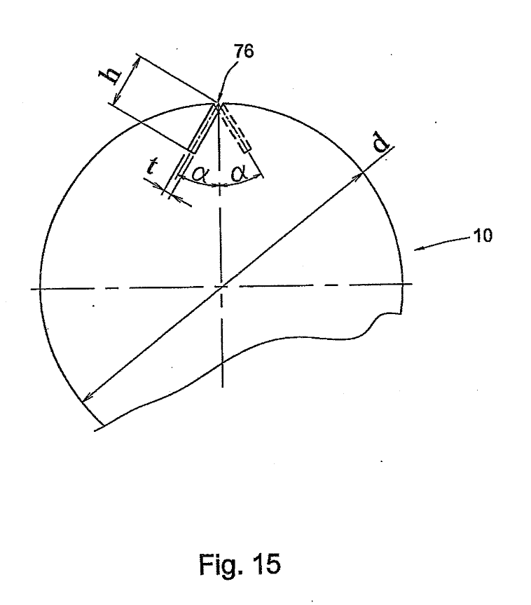

FIG. 15 shows a printing cylinder 10 with a diameter d, in which a groove 76 having a depth h is made. The diameter d may be in the order of magnitude of 100 to 600 mm, preferably 120 to 450 mm.

The groove has a thickness t and runs at an angle α with respect to a radial direction. The angle α is between 0 and 45 degrees, preferably essentially 30 degrees. The depth of the groove 76 is 5 to 35 mm, preferably 7 to 10 mm. The width of the slot is between 0.2 and 5 mm, preferably between 0.3-1.0 mm. The length of the printing cylinder may be 200 to 2000 mm, preferably 500 to 1700 mm.

The scope of the present invention is not limited to the embodiments described above, and several changes and modifications thereof are possible without departing from the scope of protection of the invention as defined in the attached claims. Thus, the cups may be made from a different metal, or even from a non-metal, such as plastic. The insert may likewise be made from plastic, for example fibre-reinforced plastic such as carbon-fibre-reinforced plastic.

The central disc of the cups preferably extends at an acute angle with respect to a radial direction of the cylinder. This acute angle can be directed at the same side as the angle which the outer edge makes with respect to the radial, but the acute angle can also be directed at the other side. In both cases, the central disc is formed by at least one conical surface. In particular, the central disc can be formed by one or more surfaces, which are oriented conically and/or radially. The conical surfaces can in this case all face the same side as the outer edge. It is likewise also possible for one, several or all conical surfaces to face the other side from the outer edge.

Instead of, or in addition to a slot, it is also possible for other coupling means for printing plates and/or rubber blanket (plates) to be provided in the insert, for example clamping means, such as clamping strips. Several types of plastic can be used for the liquid-tight outer layer, but a metal outer layer is also possible.

An insert according to the invention is particularly advantageous in combination with an at least partially open structure, since such an insert reduces the risk of moisture, such as ink or water, penetrating into the cylinder via the coupling means. The expression an at least partially open structure is in this context intended to mean a structure which comprises stiffening means for supporting the liquid-tight cylindrical outer layer. There are several stiffening means distributed over the axial length of the cylinder or sleeve, in particular at least five stiffening means are distributed over the length, more particularly at least ten. The stiffening means support the liquid-tight cylindrical outer layer over substantially its entire axial length. In particular, the stiffening means are evenly distributed over the axial length of the sleeve or cylinder. More particularly, the stiffening means are distributed continually over the length.

The stiffening means comprise a part which extends at least partially in a radial direction. In this context, the expression at least partially in a radial direction is understood to also include a direction which makes an acute angle to a radial direction. Of course, substantially completely radial directions are also possible.

The stiffening means are advantageously formed by partitions, in particular cups, as illustrated in the exemplary embodiments. In addition, internal structures using bars, for example spoke-like structures, are possible. The internal structure can also be formed by plastic foam or metal foam. In one embodiment, a counterweight may balance the printing cylinder or printing sleeve on the axis of rotation.

The described method step of shaping is advantageous, as cups can be produced using a relatively inexpensive mould, as a result of which only a relatively small investment is required in order to be able to produce several moulds for cups and thus cylinders for various diameters. Nevertheless, other ways of manufacturing are also possible, such as pressing or (injection-) molding. Instead of milling, it is also possible to produce an aperture for the insert by grinding, cutting or sawing. If (injection) molding is used, the apertures may already be pre-formed in a respective mould.

What is claimed is:

1. A printing cylinder or printing sleeve comprising:
an internal structure which is at least partially open, wherein the internal structure defines at least one hollow space;
a substantially liquid-tight cylindrical outer layer surrounding the internal structure;
a coupling device to couple a plate to the printing cylinder or printing sleeve, the coupling device being at least partially positioned in, on, or under the outer layer;
an insert supported by the internal structure, the insert being arranged at least partially around or under the coupling device, the insert being constructed to impart strength to the coupling device.

2. The printing cylinder or printing sleeve according to claim 1, wherein the outer layer includes a recess and the insert is at least one of in or under the recess.

3. The printing cylinder or printing sleeve according to claim 1, wherein the internal structure comprises partitions which support the outer layer.

4. The printing cylinder or printing sleeve according to claim 3, wherein the partitions define at least one recess to accommodate the insert therein.

5. The printing cylinder or printing sleeve according to claim 3, wherein at least a part of the partition is substantially annular or cup-shaped.

6. The printing cylinder or printing sleeve according to claim 3, wherein at least a part of the partitions comprises a conical part.

7. The printing cylinder or printing sleeve according to claim 1, wherein the insert comprises at least one abutment surface which adjoins a corresponding abutment surface on the outer layer.

8. The printing cylinder or printing sleeve according to claim 7, wherein at least one abutment surface extends obliquely with respect to a radial direction of the printing cylinder or printing sleeve.

9. The printing cylinder or printing sleeve according to claim 1, wherein the insert includes a central part and a projecting part on either side thereof, the central part having a substantially greater thickness than the projecting part viewed in a radial direction of the printing cylinder or printing sleeve.

10. The printing cylinder or printing sleeve according to claim 2, wherein at least a part of the insert is positioned under the outer layer and extends under the outer layer on either side of the recess.

11. The printing cylinder or printing sleeve according to claim 1, wherein the internal structure includes a recess and the insert is arranged in the recess and supports the outer layer in a region of the recess.

12. The printing cylinder or printing sleeve according to claim 1, wherein a portion of the insert remote from the outer layer has at least one side which extends obliquely with respect to a radial direction of the printing cylinder or printing sleeve and which contacts the internal structure.

13. The printing cylinder or printing sleeve according to claim 1, further comprising at least one counterweight to balance the printing cylinder or printing sleeve on an axis of rotation of the printing cylinder or printing sleeve.

14. The printing cylinder or printing sleeve according to claim 1, wherein the insert supports the coupling device in a region of the at least one hollow space.

15. A method for producing a printing cylinder or printing sleeve, comprising:
providing an internal structure which is at least partially open, wherein the internal structure defines at least one hollow space;
providing a substantially liquid-tight cylindrical outer layer surrounding the internal structure;
providing a coupling device to couple a plate to the printing cylinder or printing sleeve, the coupling device being at least partially positioned in, on or under the outer layer; and
providing an insert around or under the coupling device, the insert being designed to impart strength to the coupling device and the insert being supported by the internal structure.

16. The method according to claim 15, including:
providing the outer layer first around the internal structure;
creating a recess subsequently in the outer layer; and then
fitting the insert in the recess.

17. The method according to claim 15, including applying the outer layer first to the printing cylinder or printing sleeve; and installing the insert subsequently.

18. The method according to claim 15, including installing the insert first and then applying the outer layer.

19. The method according to claim 15, further comprising providing the outer layer with a recess, and fitting the insert at least partially in the recess.

20. The printing cylinder or printing sleeve according to claim 1, wherein the coupling device comprises a groove.
